(19) United States
(12) Patent Application Publication
(10) Pub. No.: US 2002/0158566 A1
(43) Pub. Date: Oct. 31, 2002

(54) Low-pressure mercury vapor discharge lamp

(76) Inventors: Willem Johannes Van Den Bogert, Eindhoven (NL); Hindrik Hermannus Stel, Eindhoven (NL)

Correspondence Address: Corporate Patent Counsel, U.S. Philips Corporation, 580 White Plains Road, Tarrytown, NY, 10591, US

(21) Appl. No.: 10/106,983

(22) Filed: Mar. 26, 2002

(30) Foreign Application Priority Data
Mar. 29, 2001 (EP) 01201181.3

(51) Int. Cl. H01J 1/62

(52) U.S. Cl. 313/490

(57) ABSTRACT

A low-pressure mercury vapor discharge lamp is provided with a discharge vessel (10). The discharge vessel (10) has tubular end portions (11; 11′), each having a longitudinal axis (12; 12′). The discharge vessel (10) encloses a discharge space (18) containing a filling of mercury and an inert gas in a gastight manner. Electrodes (20; 20′) are arranged in the discharge space (18). An auxiliary amalgam (27) is mounted close to the electrodes (20; 20′). According to the invention, the auxiliary amalgam (27) is fixed to a part of the lamp, without a separate carrier, so as to be electrically insulated with respect to the electrode (20; 20′).

The invention relates to a low-pressure mercury vapor discharge lamp comprising a discharge vessel,

which discharge vessel encloses a discharge space containing a filling of mercury and an inert gas in a gastight manner, said discharge vessel comprising tubular end portions each having a longitudinal axis,

electrodes being arranged in the discharge space for generating and maintaining a discharge in the discharge space, and at least one auxiliary amalgam being provided in the discharge vessel in the vicinity of at least one of the electrodes.

In mercury vapor discharge lamps, mercury forms the primary component for (efficiently) generating ultraviolet (UV) light. An inner wall of the discharge vessel may be provided with a luminescent layer comprising a luminescent material (for example a fluorescent powder) to convert UV to other wavelengths, for example to UV-B and UV-A for producing tan artificially (sunbed lamps) or to visible radiation for general lighting purposes. For this reason, such discharge lamps are also referred to as fluorescent lamps. The discharge vessel of low-pressure mercury vapor discharge lamps is generally circular in shape and comprises both elongated and compact embodiments. In general, the tubular discharge vessel of so-termed compact fluorescent lamps comprises a collection of comparatively short straight parts of comparatively small diameter, which straight parts are interconnected, on the one hand, by means of bridge portions and/or, on the other hand, via curved portions. Compact fluorescent lamps are generally provided with a(n) (integrated) lamp cap.

In the description and in the claims of this invention, the expression “nominal operation” is used to indicate operating conditions where the mercury vapor pressure is such that the radiation output of the lamp is at least 80% of that during optimum operation, i.e. under operating conditions where the mercury vapor pressure is optimal. Furthermore, in the description and in the claims, the “initial radiation output” is defined as the radiation output of the discharge lamp 1 second after switching on the discharge lamp, and the “run-up time” is defined as the time needed by the discharge lamp to attain a radiation output of 80% of the radiation output during optimum operation.

A low-pressure mercury vapor discharge lamp as mentioned in the opening paragraph is known from U.S. Pat. No. 5,204,584. The known low-pressure mercury vapor discharge lamp comprises a suitable combination of a main amalgam and an auxiliary amalgam.

In the known discharge lamp, the auxiliary amalgam is applied to one of the current supply conductors which extend from the electrodes, via a so-termed stem in the tubular end portion, beyond the limits of the discharge vessel. Particularly in so-termed cold-start low-pressure mercury vapor discharge lamps this causes material to be sputtered off the auxiliary amalgam and deposited onto the tubular end portions of the discharge vessel. Without being obliged to give any theoretical explanation, the inventors hold the opinion that said problem is caused by cold-igniting the discharge lamp, whereby, shortly after starting the lamp, the discharge acts on the (still) cold emitter as well as on the auxiliary amalgam, which results in a discharge on the emitter and on the auxiliary amalgam. The discharge on the auxiliary amalgam sputters the amalgam off the carrier and causes blackening of the tubular end portions and a poor run-up behavior. Sputtering as well as blackening are both undesirable. In addition, the service life of the lamp is adversely affected if any amalgam originating from the auxiliary amalgam lands on the electrode. The effect is further enhanced by the comparatively substantial cathode fall that is characteristic of cold-start low-pressure mercury vapor discharge lamps.

It is an object of the invention to provide a lamp of the type described in the opening paragraph, wherein the drawbacks of the prior art, particularly regarding the above-mentioned sputtering and blackening, are obviated, which consequently leads to a longer service life of the lamp.

To achieve this, in accordance with the invention, the low-pressure mercury vapor discharge lamp is characterized in that said auxiliary amalgam is provided, without a separate carrier, on a part of the lamp so as to be electrically insulated with respect to the electrode. As the auxiliary amalgam is electrically insulated from the electrode, said auxiliary amalgam is at the same potential as its environment and will not attract ions that are present in the discharge. This results in an improved run-up behavior of the discharge lamp, and blackening of the tubular end portions of the low-pressure mercury vapor discharge lamp is substantially precluded. The auxiliary amalgam is heated by the discharge in a manner comparable to that in induction lamps. By applying the auxiliary amalgam directly, i.e. (without a separate carrier) on a part of the lamp that is naturally present therein, an elegant construction is obtained which can be manufactured in a simple and hence economical manner.

In a preferred embodiment of a low-pressure mercury vapor discharge lamp in accordance with the invention, a stem in the tubular end portion carries the electrode, the auxiliary amalgam being bonded to the stem by means of, in particular, an adhesive.

In a further preferred embodiment of a low-pressure mercury vapor discharge lamp in accordance with the invention, the auxiliary amalgam is bonded to the inner wall of the discharge vessel by means of, in particular, an adhesive.

In a further preferred embodiment of a low-pressure mercury vapor discharge lamp in accordance with the invention, the auxiliary amalgam is bonded to a current supply conductor of the electrode. For bonding use can be made of an electrically insulating adhesive or an electrically insulating clamped joint, as will be described in greater detail hereinafter with reference to the drawings.

In a further preferred embodiment of a low-pressure mercury vapor discharge lamp in accordance with the invention, the auxiliary amalgam is arranged on a side of the electrode facing away from the discharge space. In this embodiment, the auxiliary amalgam is situated between the stem and the electrode. In this manner, a simple construction is obtained.

In general, a low-pressure mercury vapor discharge lamp comprising an auxiliary amalgam with sufficient mercury has a comparatively short run-up time. When the lamp is switched on, the auxiliary amalgam is heated by the electrode, so that the auxiliary amalgam comparatively rapidly gives off a substantial part of the mercury contained therein. It is desirable that the lamp has been inoperative for a sufficiently long period of time before it is switched on again, so as to allow the auxiliary amalgam to take up sufficient mercury. If the lamp has been inoperative for a comparatively short period of time, the reduction of the run-up time is only small. In addition, the initial radiation output is lower (still) than that of a lamp comprising only a main amalgam, which can be attributed to the fact that the auxiliary amalgam causes the setting of the mercury vapor pressure in the discharge space to be comparatively low. In addition, a further drawback that applies to comparatively long lamps resides in that the mercury released by the auxiliary amalgam takes comparatively much time to spread throughout the discharge vessel, as a result of which such lamps have a comparatively bright zone near the auxiliary amalgam and a comparatively dark zone away from the auxiliary amalgam, which situation continues for several minutes after the lamp has been switched on.

Thus, a drawback of the low-pressure mercury vapor discharge lamp known from said United States patent specification resides in that the run-up time is comparatively long in spite of the use of an auxiliary amalgam.

To obviate this drawback, in a further preferred embodiment of a low-pressure mercury vapor discharge lamp in accordance with the invention, the auxiliary amalgam is arranged in a plane transverse to the longitudinal axis.

The auxiliary amalgam in the low-pressure mercury vapor discharge lamp in accordance with the invention is provided so as to be rotated through 90° as it were with respect to the known discharge lamp, so that the major part of the carrier is arranged parallel to the electrode. Without being obliged to give any theoretical explanation, the inventors hold the opinion that the reduction of the run-up time is caused by the fact that a part of the mercury that is detached from the auxiliary amalgam on the carrier lands farther down the discharge vessel of the low-pressure mercury vapor discharge lamp. As a result, in a short period after starting the discharge lamp, the back-diffusion process of mercury towards the cold spots on the side of the electrodes facing away from the discharge space takes longer than in the known lamp. By virtue thereof, more mercury is available at locations in the discharge space that heat up comparatively rapidly, which gives rise to an improved run-up behavior.

These and other aspects of the invention will be apparent from and elucidated with reference to a number of embodiments described hereinafter.

In the drawings:

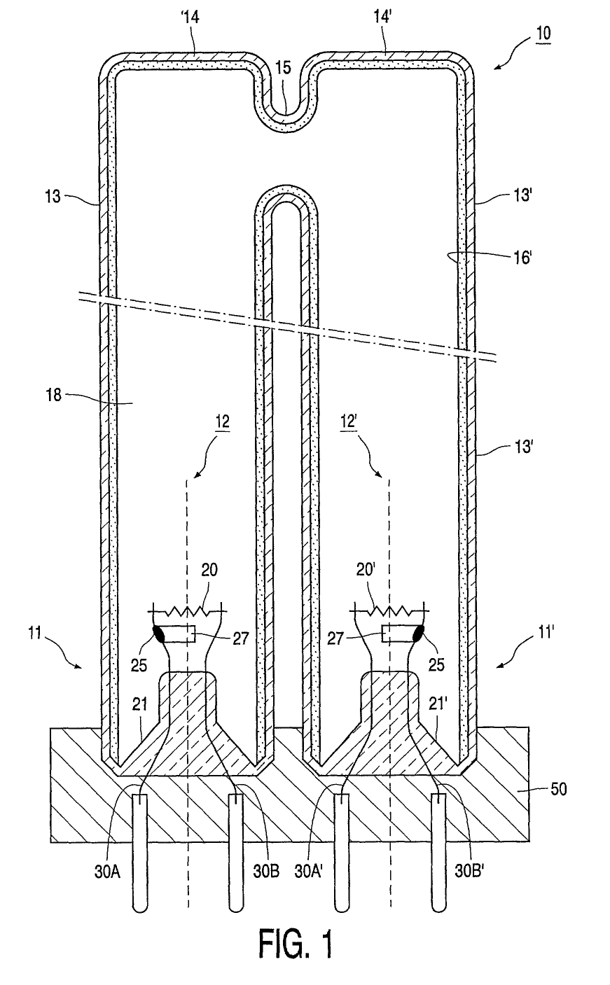

FIG. 1 is a cross-sectional view of a first embodiment of the low-pressure mercury vapor discharge lamp in accordance with the invention;

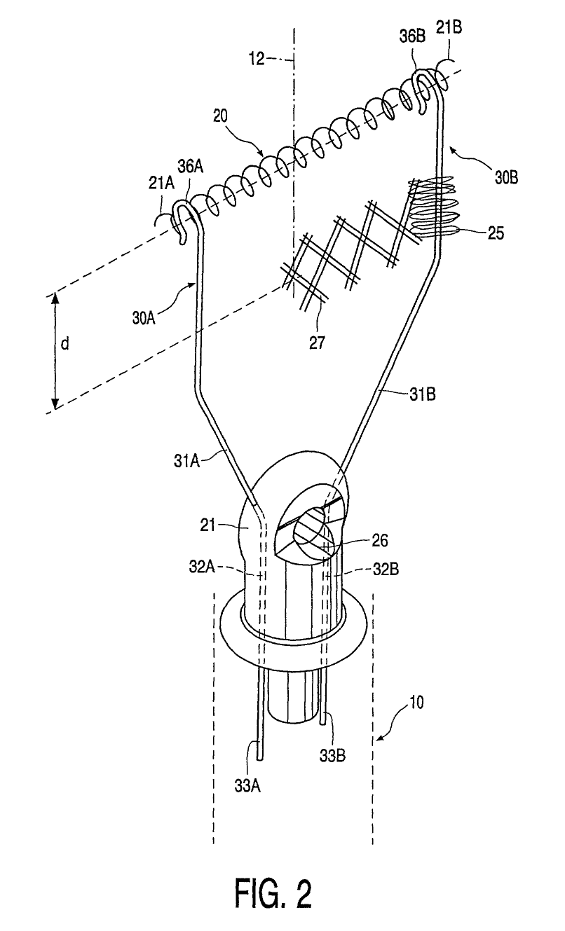

FIG. 2 is a perspective view of a detail of the discharge lamp of FIG. 1;

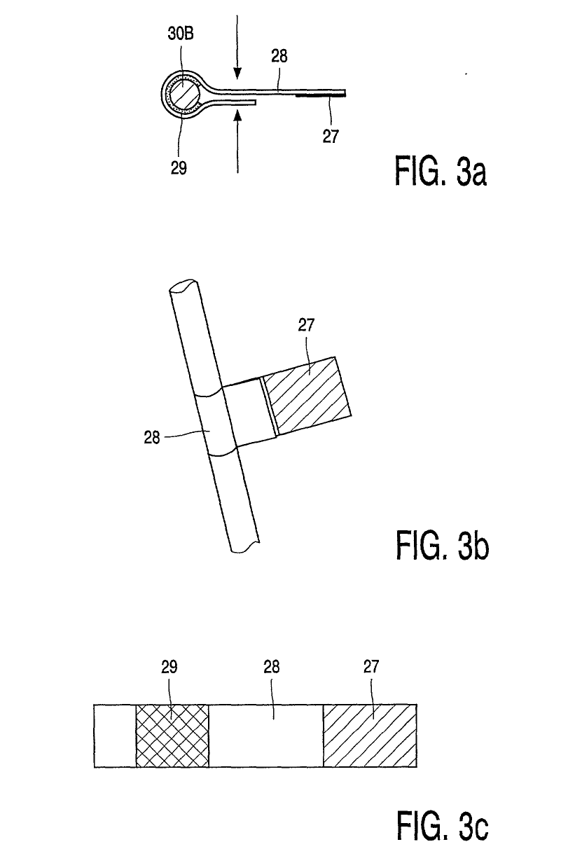

FIG. 3 shows a few details of a second embodiment of the low-pressure mercury vapor discharge lamp in accordance with the invention;

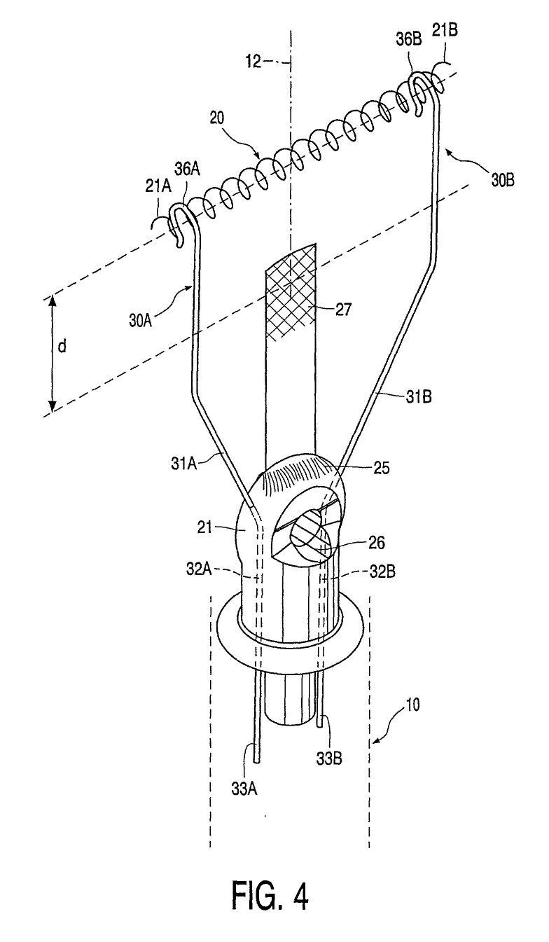

FIG. 4 corresponds to FIG. 2, however, in this case it relates to a third embodiment of the low-pressure mercury vapor discharge lamp in accordance with the invention; and

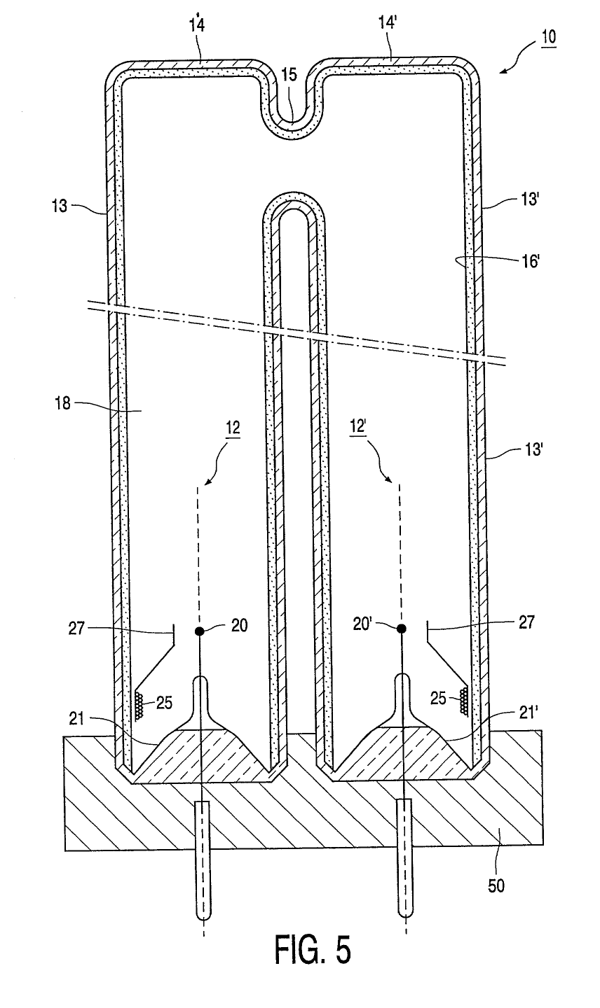

FIG. 5 corresponds to FIG. 1, however, in this case it shows a different side view that relates to a fourth embodiment.

The Figures are purely diagrammatic and not drawn to scale. Particularly for clarity, some dimensions are exaggerated strongly. Wherever possible, in the Figures like reference numerals refer to like parts.

FIG. 1 shows a first embodiment of a low-pressure mercury vapor discharge lamp in accordance with the invention comprising a (glass) discharge vessel 10 having tubular end portions 11; 11′. The discharge vessel 10 encloses a discharge space 18 in a gastight manner, which discharge space contains an ionizable filling comprising less than 3 mg mercury and an inert gas, for example a 75/25 mixture of argon and neon. In the embodiment shown, the discharge vessel 10 has two tube portions 13; 13′ each having a tubular end portion 11; 11′ with a longitudinal axis 12; 12′. The end portions 11; 11′ are jointly fitted in a lamp cap 50, which is very diagrammatically shown. In an alternative embodiment, a so-termed integrated lamp cap is used, wherein a copper-iron ballast or an electronic gear control is housed, and which lamp cap is further provided with, for example, so-termed E14 or E27 connection means. At the location of the tube end portions 14; 14′, which are situated opposite the lamp cap 50, the tube portions 13; 13′ communicate with each other via a channel 15. The discharge vessel may alternatively be embodied so as to be, for example, a single extended tube or a (multiple-) bent tube, for example a tube bent so as to be hook-shaped. On a side facing the discharge space 18, the discharge vessel 10 is provided with a luminescent layer 16′. In each end portion 11; 11′, an electrode 20; 20′ is arranged on a so-termed stem 21, 21′ in the discharge space 18. The electrode 20; 20′ is preferably arranged so as to extend transversely to the longitudinal axis. In an alternative embodiment of the low-pressure mercury vapor discharge lamp, the electrode is axially mounted in the end portion. Furthermore, in a further alternative embodiment of the low-pressure mercury vapor discharge lamp, an external electrode may be provided at an end portion of the discharge vessel to capacitively couple the lamp to a lamp power supply. From the electrodes 20, 20′, current supply conductors 30A, 30B; 30A′, 30B′ extend through the stem 21; 21′ in the end portion 11; 11′ beyond the limits of the discharge vessel 10. Near the electrodes 20; 20′, an auxiliary amalgam 27 is bonded to each current supply conductor 30A; 30B′ by means of an electrically insulating adhesive or cement 25. As a result, the auxiliary amalgam 27 is at the same potential as the surroundings and will not attract ions that are present in the discharge. In this manner, the auxiliary amalgam 27 can be attached to the current supply conductor 30A; 30B′ in a manner that is both rapid and simple in practice.

FIG. 2 is a perspective view of a detail of the discharge lamp shown in FIG. 1. In FIG. 2, the discharge vessel 10 is represented by means of dashed lines. The auxiliary amalgam 27, in this example lead-tin-mercury or indium-mercury, is applied to the current supply conductor 30B by means of an electrically insulating adhesive 25. The auxiliary amalgam may be in the form of a plate and/or comprises, preferably, a network of woven wire onto which the auxiliary amalgam material is deposited. In an alternative embodiment, the auxiliary amalgam 27 is made of a dense length of strip stock wherein small incisions are made, after which the strip is stretched so as to obtain an open structure. The auxiliary amalgam material is deposited on such a structure. In the example shown in FIGS. 1 and 2, the auxiliary amalgam 27 is arranged on a side of the electrode 20; 20′ facing away from the discharge space 18. In this embodiment, the auxiliary amalgam 27 is situated between the stem 21; 21′ and the electrode 20; 20′.

In an alternative embodiment, the auxiliary amalgam 27 is arranged in the discharge space on a side of the electrode facing away from the stem in the tubular end portion of the discharge lamp. In this embodiment, the auxiliary amalgam 27 is placed in the discharge in a manner corresponding to the way in which auxiliary amalgams are placed in electrodeless discharge lamps, which are also referred to as induction lamps.

FIG. 3 relates to a plan view (a) and a perspective view (b) of a detail of a second embodiment in accordance with the invention, wherein a strip 28 with the material of the auxiliary amalgam 27 is clamped around a current supply conductor 30B. This clamp or clip connection is obtained by winding the strip 28 around the current supply conductor 30B and subsequently exerting a compressive force in the direction of the arrows (a) until eventually situation (b) is obtained. The auxiliary amalgam 27 is electrically insulated with respect to the electrode 20; 20′ by means of an electrical insulator 29. The strip 28 actually is a small band (c), the auxiliary amalgam material being deposited at one end thereof, and the electrically insulating material of the electrical insulator 29 being provided near the other end. By winding the strip 28, from the strip-shaped starting position, around the current supply conductor 30B, a situation (a, b) is obtained wherein the electrical insulator 29 is situated between the current supply conductor 30B and the actual carrier 29 (28 akkoord ?).

FIG. 4 and FIG. 5 correspond to, respectively, FIG. 2 and FIG. 1, and corresponding parts are indicated by means of the same reference numerals. In each case use is made of an electrically insulating adhesive by means of which a strip 28 carrying the auxiliary amalgam material 27 is attached in an electrically insulating manner to, respectively, the stem 21 (FIG. 4) and the inner wall of the discharge vessel (10) (FIG. 5). In the latter case, the luminescent layer 10′ is locally absent.

In FIGS. 2, 3, 4 and 5, the current supply conductors 30A, 30B comprise a first segment 31A, 31B of iron wire having a thickness of 0.6 mm, a second segment 32A, 32B of NiFeCuMn-wire having a thickness of 0.35 mm, and a third segment 33A, 33B of CuSn-wire having a thickness of 0.4 mm, which extend substantially in, respectively, the discharge vessel 10, a wall of the stem 21, and outside the discharge vessel 10 (see FIGS. 2 and 4, wherein the second segments 32A, 32B are indicated by means of dashed lines). At the end portion 11′, the lamp is constructed in a corresponding manner (not shown in FIGS. 2 and 4).

In FIGS. 2, 3, 4 and 5, the auxiliary amalgam 27 is situated at a distance d from the electrode 20; 20′, where d>0. The distance d is measured, as indicated in FIGS. 2 and 4, from the (center of the) surface of the amalgam 27 to the center of the electrode 20; 20′. In accordance with a favorable embodiment of the invention, the distance d meets the relation:

0,5≦d≦8 mm.

A particularly suitable value for the distance d is: 1≦d≦3 mm. In this manner, a compact discharge lamp is obtained.

It will be obvious that within the scope of the invention many variations are possible to those skilled in the art.

The scope of protection of the invention is not limited to the examples described herein. The invention is embodied in each novel characteristic and each combination of characteristics. Reference numerals in the claims do not limit the scope of protection thereof. The use of the verb “to comprise” and its conjugations does not exclude the presence of elements other than those mentioned in the claims. The use of the article “a” or “an” in front of an element does not exclude the presence of a plurality of such elements.

1. A low-pressure mercury vapor discharge lamp comprising a discharge vessel (10), which discharge vessel (10) encloses a discharge space (18) containing a filling of mercury and an inert gas in a gastight manner, said discharge vessel (10) comprising tubular end portions (11; 11′) each having a longitudinal axis (12; 12′), electrodes (20; 20′) being arranged in the discharge space (18) for generating and maintaining a discharge in the discharge space (18), and at least one auxiliary amalgam (27) being provided in the discharge vessel (10) in the vicinity of at least one of the electrodes (20; 20′), characterized in that said auxiliary amalgam (27) is provided, without a separate carrier, on a part of the lamp so as to be electrically insulated with respect to the electrode (20, 20′).

2. A low-pressure mercury vapor discharge lamp as claimed in claim 1, wherein a stem (21; 21′) in the tubular end portion (11; 11′) carries the electrode (20; 20′), and the auxiliary amalgam (27) is bonded to the stem (21; 21′) by means of, in particular, an adhesive.

3. A low-pressure mercury vapor discharge lamp as claimed in claim 1, wherein the auxiliary amalgam (27) is bonded to the inner wall of the discharge vessel (10) by means of, in particular, an adhesive.

4. A low-pressure mercury vapor discharge lamp as claimed in claim 1, wherein the auxiliary amalgam (27) is bonded to a current supply conductor (30A, 30B; 30A′, 30B′) of the electrode (20; 20′).

5. A low-pressure mercury vapor discharge lamp as claimed in claim 4, wherein the auxiliary amalgam (27) is bonded by means of an electrically insulating adhesive.

6. A low-pressure mercury vapor discharge lamp as claimed in claim 4, wherein the auxiliary amalgam (27) is bonded by means of an electrically insulating clamped joint.

7. A low-pressure mercury vapor discharge lamp as claimed in any one of the claims 1 through 6, wherein the auxiliary amalgam (27) is arranged on a side of the electrode (20; 20′) facing away from the discharge space (13).

8. A low-pressure mercury vapor discharge lamp as claimed in any one of the claims 1 through 7, wherein the auxiliary amalgam (27) is arranged in a plane extending transversely to the longitudinal axis (12; 12′).

9. A low-pressure mercury vapor discharge lamp as claimed in any one of the claims 1 through 8, wherein a distance d between the auxiliary amalgam (27) and the electrode (20; 20′) lies in the range from 0.5<d<8 mm.

10. A low-pressure mercury vapor discharge lamp as claimed in claim 9, wherein a distance d between the auxiliary amalgam (27) and the electrode (20; 20′) lies in the range from 1<d<3 mm.
